(19) United States
(12) Patent Application Publication
(10) Pub. No.: US 2008/0163994 A1
(43) Pub. Date: Jul. 10, 2008

(54) Security Feature for Value Documents

(75) Inventors: Rainer Hoppe, Nurnberg (DE); Thomas Giering, Kirchseeon (DE)

Correspondence Address: GREENLEE WINNER AND SULLIVAN P C, 4875 PEARL EAST CIRCLE, SUITE 200, BOULDER, CO, 80301, US

(73) Assignees: Rainer Hoppe; Thomas Giering

(21) Appl. No.: 11/813,077

(22) PCT Filed: Dec. 15, 2005
(86) PCT No.: PCT/EP2005/013479

§ 371 Date: Jun. 28, 2007

(30) Foreign Application Priority Data
Dec. 29, 2004 (DE) 102004063217.0

(51) Int. Cl. D21H 17/36; C01G 19/02; C01G 15/00; C01F 17/00; C01G 21/02; C01G 23/04; C01G 25/02; C01G 49/02; C09K 11/08; B32B 5/16

(52) U.S. Cl. 162/140; 423/594.9; 423/600; 423/263; 423/277; 423/326; 423/598; 423/594.1; 252/301.36; 428/402

(57) ABSTRACT

The present invention relates to a security feature for security papers, value documents and the like having an acid-labile feature substance as the core and a shell consisting substantially of metal oxide, the security feature exhibiting greater stability against the action of acids compared with the acid-labile feature substance.

The present invention relates to a security feature for security papers, value documents and the like having an acid-labile feature substance as the core and a shell consisting substantially of metal oxide, the security feature exhibiting greater stability against the action of acids compared with the acid-labile feature substance. The present invention also relates to a security paper, a value document and methods for manufacturing such a security feature.

Value documents, such as banknotes, stocks, bonds, certificates, vouchers, checks, valuable admission tickets and other papers that are at risk of counterfeiting, such as passports or other identification documents, are normally provided with various security features to increase their counterfeit security. A security feature can be designed, for example, in the form of a security thread embedded in a banknote, an applied security strip or a self-supporting transfer element, such as a patch or a label, that, after its manufacture, is applied to a value document.

In the following, security paper is understood to be paper that, for example, is already furnished with security features, such as a watermark, security thread, hologram patch, etc., but is not yet circulatable and is an intermediate product in the manufacture of the value document. Value document is understood to be the circulatable product.

A security feature is normally furnished with at least one feature substance. Such feature substances are, for example, luminescent, magnetic, electrically conductive or infrared-absorbent substances.

Recently, luminescent compounds were developed on the basis of host matrices that are doped with chromophores. It has been shown that these luminescent substances are exceptionally suitable as feature substances of security features for value documents. The said compounds are described, for example, in EP 0 977 670 B1.

However, feature substances often exhibit the disadvantage of low stability toward external influences, such as oxygen, moisture, organic solvents and oxidizing and reducing substances.

To increase the stability of luminescent powder, that is, compounds of the chemical composition Y₂SiO₅:Tb; ZnS:Cu,AU,Al; Zn,CdS:Cu,Al; CaS:Ce; Y₂O₂S:Eu; Y₂O₃:Eu; CaS:Eu and ZnS:Ag, EP 0 700 979 A2 proposes coating the luminescent powder. For this, the luminescent powders are dispersed in a solution that includes one or more types of silicon-organic compounds and, if applicable, metallo-organic compounds of further elements. For this, an aqueous solvent mixture that exhibits a pH value between 1 and 5 is used.

For a number of feature substances, the coating proposed by EP 0 700 979 A2 cannot be used. A particular problem is posed, namely, by the sensitivity of these feature substances to acidic media, through which the feature substances are chemically altered or even completely decomposed. A coating according to the method of EP 0 700 979 A2 that is carried out at a pH value between 1 and 5 is thus excluded in these cases. The sensitivity of the feature substances to acids is also the decisive impediment to their use in security elements of value documents. When used in value documents, namely, the feature substances must satisfy high requirements for the stability of their machine-readable or visually perceptible properties. By nature, however, value documents and especially banknotes very frequently come into contact with human skin, which, as is well known, exhibits an acidic pH value between 5.5 and 6.5. Through the repeated contact with this acidic medium, a chemical change occurs in the feature substances, which inevitably causes a change in the machine-readable or visually perceptible properties.

Thus, a number of compounds themselves exhibit physical properties that make them exceptionally suitable as feature substances of value documents, but these physical properties change very quickly when actually used, which can cause the check of the authenticity of the value document to yield incorrect results. Use as the feature substance in value documents is thus not possible.

Based on that, the object of the present invention is to provide security features that, compared with the security features known from the background art, exhibit greater resistance to external influences, especially to the action of acidic media.

This object is solved by the security feature having the features of the main claim. A security element having such a security feature, a security paper for the manufacture of security documents having such a security feature, a value document having such a security feature, and manufacturing methods for such a security feature are the subject of the coordinated claims. Developments of the present invention are the subject of the dependent claims.

The security feature according to the present invention for security papers, value documents and the like comprises an acid-labile feature substance that serves as the core of the security feature, and a shell consisting substantially of metal oxide. The security feature according to the present invention exhibits greater stability against the action of acids compared with the acid-labile feature substance.

In the context of the present invention, the terms “capsule” or “mantle” are understood to mean a complete layer composed of material that surrounds the acid-labile core. As described below, this layer is built up by a condensation reaction of precursor compounds. By nature, it can happen that the formation of the shell terminates at one location and the core is thus not completely encased, but much rather, the layer exhibits gaps. In this case, in the following, the term “coating” is used. The term “shell” is used as a generic term for “mantle”, “capsule” and “coating”. Thus, this term includes both completely and incompletely coated cores.

Under real conditions, an extremely large quantity of individual security features is always manufactured by a method according to the present invention. Due to the fact that practically every chemical reaction does not proceed completely to its thermodynamic equilibrium, but rather is also kinetically controlled to a certain degree, a portion of the security features depicted will always be surrounded by a complete shell, while another portion exhibits only an incomplete coating.

The security features provided with a complete shell and, to a lesser extent, also those provided with a slightly patchy coating exhibit the advantage of a significantly greater resistance to the action of acids, and thus greater longevity. Moreover, skin-irritating effects of acid-labile cores or their decomposition products, or even effects that are toxic to humans, can be diminished or excluded.

In the context of the present invention, the acid stability of feature substances is assessed with a view to the stability of the physical properties of the feature substances when acted on by an acidic medium. As already mentioned, when used in value documents, the feature substances must satisfy high requirements for the stability of their machine-readable or visually perceptible properties. Through contact with an acidic medium, a chemical change may occur in the feature substances, which inevitably causes a change in the machine-readable or visually perceptible properties.

Thus “acid-labile feature substances” are understood to be feature substances that change their machine-readable or visually perceptible physical properties when acted on by an acidic medium. Greater acid stability of the inventive security features compared with these acid-labile feature substances is given when their maschine-readable or visually perceptible physical properties, when acted on by an acidic medium, preferably do not change or change only to such a small extent that a check of a certain physical property within the context of an authenticity test does not yield a falsified result. In the context of the present invention, a check does not yield a falsified result even when, following the action of an acidic medium, the physical property changes by a maximum of 50%, preferably a maximum of 30%, particularly preferably a maximum of 10% compared with the property before the action of an acidic medium. Accordingly, for example, a luminescent substance is considered acid stable if, following the action of an acidic medium, the intensity of the luminescence emission does not fall below 50% of the intensity measured prior to the action of an acidic medium.

The terms “lacid stability” and “lacid lability” can also be differentiated from one another with the aid of common banknote tests. An “acid-labile feature substance” is present especially when the feature substance does not satisfy the usual banknote tests and easily decomposes under the action of acids. Greater acid stability compared with this acid-labile feature substance is present especially when the encapsulated or coated security features pass the common banknote tests, or in other words, do not decompose under the experimental conditions applied there, and their physical properties do not change substantially.

To check a physical property, the following banknote tests can be carried out:

A sample sheet (size: 6.2×12.0 mm, weight: 100 g/m²)—furnished with a feature substance—is laid in 100 ml acetic acid (20%, pH=1.80) at 25° C. for 30 minutes. Instead of acetic acid, hydrochloric acid (5%, pH=0.38) or sulfuric acid (2%, pH=0.28) can also be used. After the sample sheet is dried, the physical property is measured and compared with the value prior to the action of the acid.

In a further test, the above-mentioned sample sheet is laid in 100 ml synthetic sweat (DIN 53160, pH=2.8-3) at 40° C. for 30 minutes. The physical property is measured as above.

According to a preferred embodiment of the present invention, one or more luminescent substances having characteristic luminescence properties are used as the acid-labile feature substance. As already mentioned, luminescent substances have been developed recently on the basis of host matrices that are doped with certain chromophores. It has been shown that these luminescent substances are exceptionally suitable as feature substances of security features for value documents. In the context of the present invention, these luminescent substances are particularly preferably used as the acid-labile core.

In addition, magnetic substances, electrically conductive substances or substances that are absorbent in the infrared wavelength range are frequently used as feature substances for value documents. The great majority of these compounds exhibit no or insufficient stability against acids and are thus likewise preferably used as the acid-labile feature substance.

The feature substance that is absorbent in the infrared wavelength range is preferably the compound that comprises sulfides, fluorides, oxides and/or mixed oxides, especially of indium, arsenic, antimony, gallium and/or tin. Particularly preferably, the feature substance is indium tin oxide. To control the desired IR absorption properties, the tin content of the indium tin oxide In₂O₃: Sn can be varied. Preferably, the indium tin oxide exhibits a tin content of 1 to 8 mol % tin. Particularly preferably, of 5 to 8 mol %, very particularly preferably of 7 mol %.

The acid-labile core can, of course, also comprise a mixture of multiple luminescent substances, a mixture of multiple magnetic substances, a mixture of multiple electrically conductive substances or a mixture of multiple IR absorbers. Similarly, the core can also consist of a mixture of luminescent substances, magnetic substances, electrically conductive substances and/or IR absorbers. Likewise comprised in the present invention are cores composed of a mixture of multiple luminescent substances, multiple magnetic substances, multiple electrically conductive substances and multiple IR absorbers.

As the metal component of the shell consisting substantially of metal oxide, preferably an element selected from the group consisting of aluminum, barium, lead, boron, lanthanum, magnesium, silicon, titanium, zinc, zircon, cobalt, copper, iron and their mixtures is used. Particularly preferably, a metal selected from the group consisting of aluminum, silicon, titanium, zircon and their mixtures is used. Very particularly preferably, the shell of the security element consists substantially of silicon oxide.

Besides the main component of the shell, so besides the one or the multiple types of metal oxides, one or more types of metal organyl compounds Me(OR)ₙ with n=1, 2, 3, 4, 5, 6 can additionally be present in the shell of the security element. The radical labeled “R” is an organic radical that can be identical or different. The compounds Me(OR)ₙ represent precursor compounds from which, through condensation reactions that are described in greater detail below, the metal oxide shell of the inventive security features is assembled. Since it is to be expected that the condensation reactions will not always proceed to completion, a portion of the precursor remains in the shell unchanged or partially condensed. Following the condensation reaction, optionally, a temperature treatment can follow, preferably at 200 to 1000° C., particularly preferably at 300 to 500° C. This preferably results in a completion of the condensation reactions. The designation Me(OR)ₙ is a schematic notation for a chemical compound consisting of metal, oxygen and organic radicals. The index n, so the number of radicals R present, is determined by the number of valences of the metal Me, which can be from 1 to 6. In the following, a whole range of compounds is specified that fall under the designation Me(OR)ₙ, to mention here just the substances diethoxy-dimethoxysilane and tributoxyaluminum by way of example. Of course a certain type of metal precursor can also include different radicals “R”. In the cited example diethoxy-dimethoxysilane, for instance, two methyl radicals and two ethyl radicals are present.

In advantageous embodiments, R is selected from the group consisting of alkyl-, alkenyl-, alkynyl-, allyl-, amino-, aryl-, benzyl-, carboxyl-, epoxy- and their mixtures. Particularly preferably, the organic radicals methyl-, ethyl-, propyl-, butyl- or 2-methoxyethoxy- are used.

The size of the cores or of the security features is usually based on the intended use.

According to the present invention, the diameter is preferably larger than 1 μm. This core size is suitable, for example, for use in screen printing methods or for the introduction of the security features into the paper at manufacture.

According to an advantageous embodiment of the present invention, the core exhibits a diameter that measures between 1 μm and 50 μm, preferably between 1 μm and 20 μm, and particularly preferably about 10 μm. These diameters are suitable especially for luminescent, magnetic or electrically conductive compounds.

According to an advantageous embodiment of the present invention, the core exhibits a diameter less than 1 μm, particularly preferably less than 600 nm. This core size is suitable, for example, for use in the inkjet method. These diameters are suitable especially for IR-absorbent compounds.

The security feature consisting of core and shell preferably exhibits a diameter that measures between 0.5 μm and 60 μm and particularly preferably between 1 μm and 20 μm. Preferably, 99% of all security feature particles exhibit a particle diameter less than 20 μm.

The shells preferably exhibit a thickness of 10 μm and less, particularly preferably of 1 μm and less.

With the specified diameter ranges, all types of security elements, security papers and value documents can be manufactured with no problem when the security features according to the present invention are used.

It is known that security features for value documents can comprise multiple feature substances. According to another advantageous embodiment of the present invention, this can be realized in that, in addition to the acid-labile feature substance functioning as the core of the security feature, also the shell of the security feature fulfills the function of a feature substance. The shell can, for example, exhibit characteristic luminescence, magnetic or IR absorption properties or be electrically conductive.

Characteristic luminescence properties can be achieved especially by doping with a rare earth metal, so by doping with, for example, Pr³⁺, Nd³⁺, Sm³⁺, Eu³⁺, Tb³⁺, Dy³⁺, Ho³⁺, Er³⁺, Tm³⁺ or Yb³⁺. The shell is thus preferably doped with one or more of these elements. The doping is done simply, for example by adding the appropriate precursor compounds Me(OR)₃ prior to the condensation reaction of the metal oxide precursor that makes up the main component of the shell.

The present invention also comprises a security element for security papers, value documents and the like, the security element including one or more security features as specified above.

These security elements can be designed, for example, in the form of a security strip, a security thread, a security band or a transfer element for application to a security paper, value document or the like.

Furthermore, the present invention comprises a security paper for manufacturing security documents, such as banknotes, identification cards or the like, the security paper including one or more security features as specified above, and/or being furnished with one or more security elements as specified above. Preferably, when manufacturing paper, the security feature(s) is/are added to the paper pulp. In a further preferred variant, the feature substance(s) is/are printed on the paper in suitable form. The inkjet method is preferably used for printing the IR-absorbent security feature.

In addition, the present invention comprises a value document, such as a banknote, a passport, an identification document or the like, the value document including one or more of the above-specified security features and/or being furnished with one or more of the above-specified security elements and/or exhibiting one of the above-specified security papers. As already mentioned, acid-labile feature substances that form the core of the security feature according to the present invention are exceptionally suitable for the counterfeit-proof marking of value documents. The value document can likewise include a window area covered with the security element or a hole covered therewith.

The present invention also comprises the use of the above-specified security features for manufacturing security paper.

Furthermore, the present invention also comprises the use of one of the above-described security features, one of the above-described security elements, one of the above-described security papers or one of the above-described value documents for securing goods of any kind.

The manufacture of the security features according to the present invention can, in principle, occur through all methods known from the background art for coating small particles. In this context, a distinction is made between physicomechanical methods and chemical methods. As physicomechanical methods, spray drying, multi-component nozzle methods, dipping or centrifugation methods, fluidized bed coating, flow coating, electrostatic microencapsulation and vacuum encapsulation, for example, are familiar to persons skilled in the art. Chemical methods are coacervation, complex coacervation, chemical vapor deposition, phase condensation and encapsulation with synthetic film formers.

Most of these methods exhibit the disadvantage that the encapsulated reaction product must be mechanically finished for crushing. When the substances are ground, the shells generally break open at their most unstable locations, so precisely near the feature substances that are actually supposed to be protected. Acid stability is thus no longer given.

Therefore, in the context of the present invention, methods were also developed that are suitable for manufacturing a security feature, for security papers, value documents and the like, that exhibits an acid-labile feature substance as the core and a shell consisting substantially of metal oxide. Since the security features manufactured through the methods described below are to be introduced into security elements, security papers and value documents, they must exhibit a very small particle size. Thus, in any case, the manufacturing methods must be aimed at the condensation reactions not leading to a gel formation, but rather merely assembling shells around the acid-labile cores. On the one hand, these shells should ensure a stabilization against the action of acids, but on the other hand, the detection of the specific machine-readable or visually perceptible properties of the acid-labile core should still be possible also after encapsulation. The methods according to the present invention must also ensure that the condensation reactions proceed long enough to ensure a complete coating of the core, but on the other hand, do not lead to the formation of a three-dimensional gel. Preferably, the methods are chosen such that a controlled growth of the shell is given.

In this context, the pH value at which the reactions proceed is of particular importance. An acidic pH value, namely, causes not only a destruction of the dispersed acid-labile feature substances, but also a very fast crosslinking of the metal precursors and thus the formation of undesired agglomerates.

According to the present invention, the pH value of the solutions is set such that the condensation and the hydrolysis reactions proceed at approximately the same reaction speed. Thus, a clearly basic pH value of pH>8, preferably >9, must be set.

In addition to the pH value, the salt concentration of the reaction solution also influences the growth of the shell on the core. The conductivity of the reaction solution is changed as a function of the salt concentration, and the double charge layer at the core thus presumably influenced. At the optimum salt concentration, an agglomeration of the precursors is prevented and deposition in layers favored. The salt concentration can be controlled by adding salts, such as alcali or ammonium salts, such as NaCl, KCl, NH₄Cl. The addition can be made to the reaction solution or to the solid starting substances.

In principle, in the method according to the present invention, care should be taken that the condensation reactions proceed at a slow speed, since only in this case is it ensured that no or only little gel formation takes place when the metal precursors condense, and that a uniformly thick and complete coating of the feature substances occurs.

According to a first method according to the present invention, the manufacture of the inventive security features occurs by reaction of the feature substance(s) and one or more metal oxide precursors in a solvent under basic conditions at a pH>8, preferably >9. All common substances that increase the pH value can be used as the base, also substances that release the base only through heating, such as adamantane or urea.

In this case, the speed of the condensation reactions can be controlled by varying the parameters reaction duration, salt concentration, water amount, solvent, temperature, stirring and/or pH value.

According to a second method according to the present invention, the manufacture of the inventive security features occurs through dispersion of the feature substance(s) in a solvent under basic conditions at a pH>8, preferably >9, and subsequent slow dropwise addition of a liquid metal oxide precursor or of a metal oxide precursor dissolved in a solvent. In this case, the feature substances serve as the condensation nuclei for the condensation of the metal oxide precursor.

In this case, the speed of the condensation reactions and the quality of the reaction products can be controlled by varying the parameters salt concentration, reaction duration, water amount, solvent, temperature, stirring and/or pH value. It has proven to be particularly advantageous to carry out the dropwise addition of the dissolved metal oxide precursor with vigorous stirring of the presented dispersion of the feature substance. In this way, the metal oxide precursor dissolved in, for example, ethanol is present in the form of very small drops within the dispersion of the feature substance. The condensation of the metal oxide precursor molecules among each other, and thus a gel formation, is thereby prevented.

According to a third method according to the present invention, the manufacture of the inventive security features occurs through dispersion of the feature substance(s) and dissolution of one or more types of metal oxide precursors in a solvent at a neutral or slightly basic pH value and subsequent slow dropwise addition of a base.

In this case, the speed of the condensation reactions can be controlled by varying the parameters salt concentration, water amount, temperature, stirring and/or addition speed of the base.

Under said basic reaction conditions, the hydrolysis of the metal oxide precursors initially occurs according to the formula:

Me(OR)ₙ+nH₂O→Me(OH)ₙ+n ROH (I)

If the acid-labile feature substances exhibit reactive groups that are capable of condensation with the metal oxide precursor, then a chemical bond occurs between the core and the shell of the security feature according to the present invention. Such a condensation of the metal oxide precursors with the feature substance FS follows the formula:

FS—OH+HO-Me(OH)ₙ₋₁→FS—O-Me(OH)ₙ₋₁+H₂O (II)

If the feature substances that form the core are furnished with multiple OH groups, then in a next step, the condensation occurs with a further metal oxide precursor molecule:

FS(OH)—O-Me(OH)ₙ₋₁+HO-Me(OH)ₙ₋₁→FS(—O-Me(OH)ₙ₋₁)₂+H₂O (III)

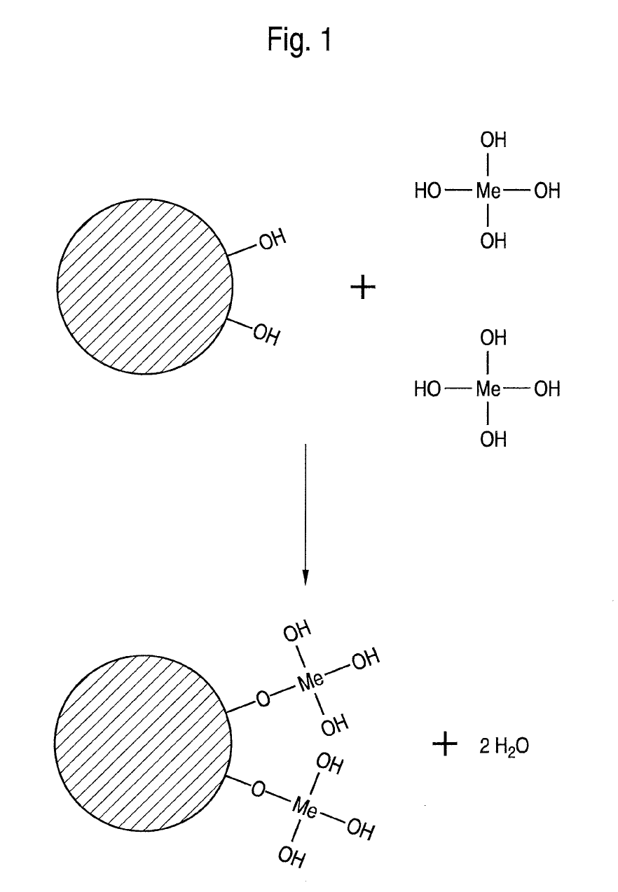

Reactions (II) and (III) are illustrated schematically in FIG. 1 for a quadrivalent metal. The feature substance FS is depicted as a hatched circle in FIG. 1 and FIGS. 2 to 4 mentioned below. This illustration corresponds to a section through a feature substance that is visualized abstractly as a sphere.

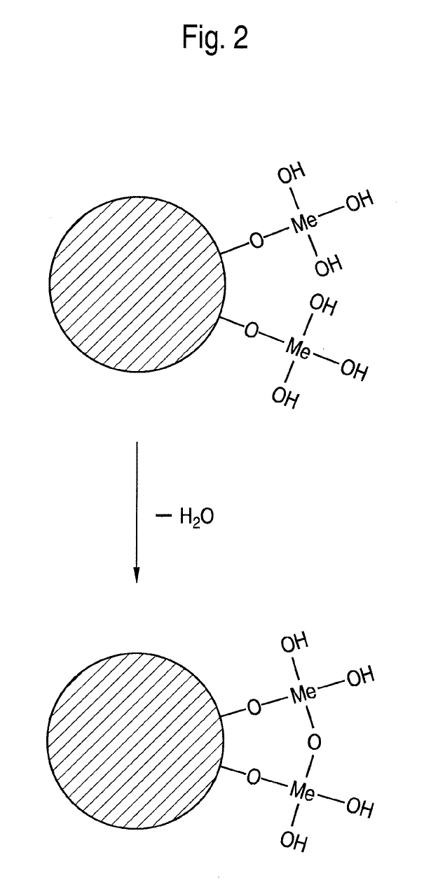

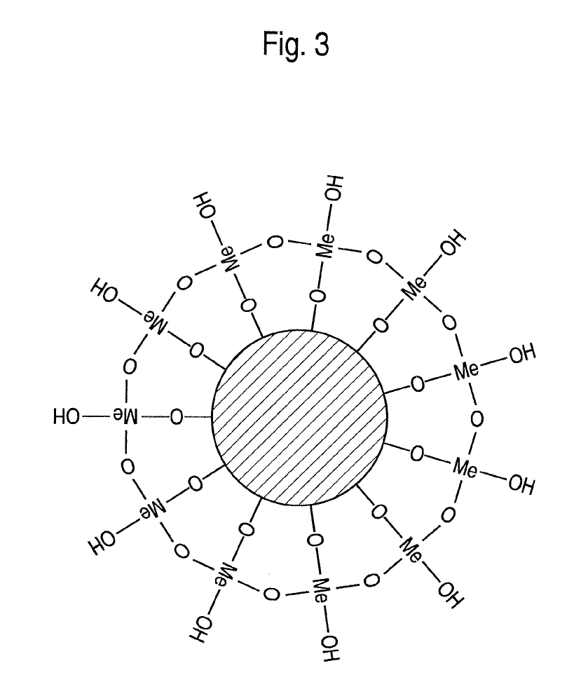

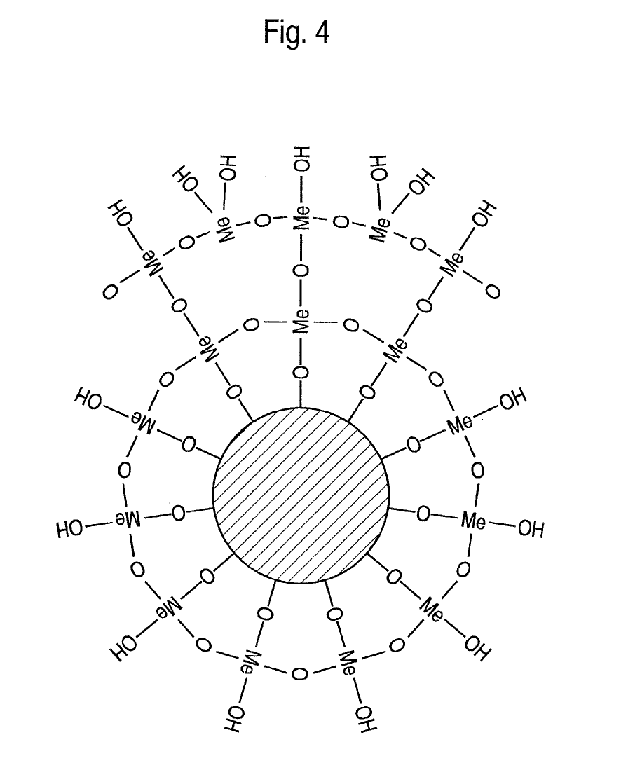

The two metal oxide precursors bound to the feature substance can now condense with each other according to the diagram illustrated in FIG. 2. In further condensation steps, a complete shell of metal oxide forms around the feature substance (see FIG. 3). When the reaction is continued, the formation of further layers of metal oxide around the core begins. The beginning of this process is illustrated schematically in FIG. 4.

Through the methods according to the present invention, which are carried out at a basic pH value, the condensation of multiple metal oxide precursors that leads to gel formation is to be prevented, if at all possible. Such condensation reactions can be described schematically for a quadrivalent metal by the following two reaction types:

≡Me-OR+HO-Me≡→≡Me-O-Me≡+ROH (IV)

≡Me-OR+HO-Me≡→≡Me-O-Me≡+ROH (V)

If, for example, tetraethoxysilane is assumed as the metal precursor, then the gel formation occurs through multiple reaction according to the summary condensation:

2Si(OCH₂CH₃)₄+H₂O→(CH₃CH₂O)₃—Si—O—Si—(OCH₂CH₃)₃+2CH₃CH₂OH (VI)

In this way, with advancing reaction progress, three-dimensional networks of (SiO)ₓ form, which is considered disadvantageous in the context of the present invention, since the introduction of the security features into security elements, security paper or value documents is considerably hindered when a gel is present.

Both protic and aprotic solvents can be used as the solvent, especially water, ethanol, isopropanol, butanol or mixtures thereof.

In a preferred embodiment of the methods according to the present invention, water, ethanol or a water/ethanol mixture is used as the solvent.

Advantageously, an aqueous ammonia solution is added to set the basic conditions.

In a preferred embodiment, the feature substances are provided with an adhesion promoter prior to the application of the shell. The adhesion promoter is, for example, an amino-methoxy functional compound, such as ADDID 900 from Wacker Chemie or APS (3-(2-aminoethylamino)propyl-trimethoxysilane), or other suitable substances, such as KR44 from Wacker Chemie (isopropyl-tri(N-ethylenediamino)ethyl titanate). Preferably, the feature substance is first dispersed in the solvent and the adhesion promoter added to the dispersion. The adhesion promoters hydrolyze autocatalytically. After a first thin coating of the adhesion promoter has settled on the feature substance, the pH value is increased, if applicable, to >8, preferably >9, and in a further step, the shell is applied according to one of the methods described.

The speed of the reactions is influenced by the concentration of the substances used, the temperature, the water amount, the reaction time, the addition time, the solvent used, and by the pH value set.

The use of adhesion promoters improves the adhesion of the shell to the feature substance and also protects against integration of foreign ions into the network of the shell.

In a further preferred embodiment, the shell can be embodied as a double shell. In a first step, preferably, the feature substance is dispersed in a solvent at basic conditions (pH preferably >8, particularly preferably >9) and, subsequently, the metal oxide precursor slowly added dropwise. The reaction product, namely the encased core, is filtered out in a second step and, as in the first step, dispersed and again converted with a metal oxide precursor. In this way, the shell is built up further. The metal oxide precursors used in the first and second step can be identical or different.

In further embodiments, the pH value setting can be achieved by using metal oxide precursors having an acid function (e.g. a carboxy group) or by setting a buffer system.

The buffer system can be, for example, the ammonium chloride/ammonium hydroxide system.

According to particularly preferred embodiments of the methods according to the present invention, one or more luminescent substances having characteristic luminescence properties, one or more magnetic substances, one or more electrically conductive substances or one or more IR absorbers or one or more dyes are added as the acid-labile feature substance. As already described in connection with the feature substances according to the present invention, also mixtures of, in each case, one and/or, in each case, multiple feature substances selected from the group consisting of luminescent substances, magnetic substances, electrically conductive substances and IR absorbers can, of course, be added.

Preferably, the metal portion of the metal oxide precursor used in the method according to the present invention is selected from the group consisting of aluminum, barium, lead, boron, lanthanum, magnesium, silicon, titanium, zinc, zircon, cobalt, copper, iron and their mixtures. Particularly preferably, a metal oxide precursor is added, the metal portion of the metal oxide precursor being selected from the group consisting of aluminum, silicon, titanium, zircon and their mixtures, and very particularly preferably, one or more types of silicon oxide precursors are added.

The methods according to the present invention are particularly easy to control and easily manageable if, as the metal oxide precursor, one or more types of metal organyl compounds Me(OR)ₙ with n=1, 2, 3, 4, 5, 6 are added, R equaling an organic radical that can be identical or different. As regards the abbreviated notation Me(OR)ₙ, in connection with the methods according to the present invention, what was said with regard to the inventive security features applies. Preferably, R is selected from the group consisting of alkyl-, alkenyl-, alkynyl-, allyl-, amino-, aryl-, benzyl-, carboxyl-, epoxy- and their mixtures, and particularly preferably, R is methyl-, ethyl-, propyl-, butyl- or 2-methoxyethoxy-.

In the context of the present invention, particularly preferred metal precursors are tetramethoxysilane, tetraethoxysilane, tetra-n-propoxysilane, tetra-n-butoxysilane and tetrakis(2-methoxyethoxy)silane.

As already described with regard to the inventive security features, according to another advantageous embodiment of the present invention, in addition to the acid-labile feature substance functioning as the core of the security feature, also the shell of the security feature can fulfill the function of a feature substance. The shell can, for example, exhibit characteristic luminescence, magnetic or IR absorption properties or be electrically conductive.

In the methods according to the present invention, this can be accomplished most easily in that, in addition to the metal oxide precursor that provides the main component of the shell, one or more further metal oxide precursors are added. In this way, characteristic luminescence properties can be achieved especially by adding, prior to the condensation reaction, one or more precursor compounds Me(OR)₃, where Me stands for a rare earth metal, especially Pr³⁺, Nd³⁺, Sm³⁺, Eu³⁺, Tb³⁺, Dy³⁺, Ho³⁺, Er³⁺, Tm³⁺ or Yb³⁺.

Good yields and a high portion of completely encapsulated acid-labile cores are obtained if, in the described methods, the reactions are carried out with stirring.

Furthermore, the formation of the shell around the core can be positively influenced in that, prior to formation of the actual shell, an adhesion promoter is applied to the surface of the core.

Likewise, the quality and quantity of the yield of security features according to the present invention can be positively influenced if the reactions are carried out at an elevated temperature.

Particularly good results are achieved if a mixture of ethanol and water is used as the solvent, the proportion of ethanol being between 5 and 30 vol. %. Most metal oxide precursors dissolve better in ethanol than in water. Thus, when a relatively low proportion of ethanol is used, the metal oxide precursors are located in the ethanol droplets within the aqueous phase. The hydrolysis of the metal oxide precursors and the following condensation reactions take place, in this case, only at the phase boundary between ethanol and water, and thus occur at an exceptionally low speed, which leads to a uniform assembly of the shell around the core.

It proves to be particularly advantageous if the reactions are carried out at a pH value between 8.8 and 9.4.

After the reactions of the metal oxide precursors and the acid-labile cores have proceeded for a predetermined time, the precipitate that forms during the course of the reaction is separated from the supernatant solution and, advantageously, subsequently washed. The separation of the precipitate advantageously occurs through filtration.

Finally, the precipitate is annealed at elevated temperatures or dried by spraying. The security features according to the present invention are thereby obtained in a form in which they can be used for manufacturing security elements, security paper and value documents. Through the annealing of the reaction products at comparatively low temperatures, frequently, a closure of the previously patchy coating to form a complete encapsulation is observed.

The methods according to the present invention can be carried out in open or closed equipment. In the case of open equipment, depending on the temperature, more or less of the alcohol that occurs when the alcoxy compounds condense can evaporate. Through this, the reaction equilibria (see formula IV and VI) and the speed of the reactions can be influenced. If NH₄OH is used as the base, the pH value can also be changed, and the reactions thus influenced, by evaporating NH₃.

1. A security feature for security papers, value documents and the like having an acid-labile feature substance as the core and a shell consisting substantially of metal oxide, characterized in that the security feature exhibits greater stability against the action of acids compared with the acid-labile feature substance, and indium tin oxide is used as the acid-labile feature substance.

2-3. (canceled)

4. The security feature according to claim 1, characterized in that indium tin oxide having a tin content of 1 to 8 mol % is used as the acid-labile feature substance.

5-6. (canceled)

7. The security feature according to claim 1, characterized in that an element selected from the group consisting of aluminum, barium, lead, boron, lanthanum, magnesium, silicon, titanium, zinc, zircon, cobalt, copper, iron and their mixtures is used as the metal of the shell consisting substantially of metal oxide.

8. The security feature according to claim 1, characterized in that an element selected from the group consisting of aluminum, silicon, titanium, zircon and their mixtures is used as the metal of the shell consisting substantially of metal oxide.

9. The security feature according to claim 1, characterized in that the shell of the security element consists substantially of silicon oxide.

10. The security feature according to claim 1, characterized in that the shell of the security element exhibits, in addition to the metal oxides, one or more types of metal organyl compounds Me(OR)ₙ, R being an organic residue that can be identical or different, and n=1, 2, 3, 4, 5, 6.

11. The security feature according to claim 1, characterized in that the shell of the security element exhibits, in addition to the metal oxides, one or more types of metal organyl compounds Me(OR)ₙ, R being selected from the group consisting of alkyl-, alkenyl-, alkynyl-, allyl-, amino-, aryl-, benzyl-, carboxyl-, epoxy- and their mixtures, and n=1, 2, 3, 4, 5, 6.

12. The security feature according to claim 10, characterized in that R is equal to methyl-, ethyl-, propyl-, butyl- or 2-methoxyethoxy-.

13. The security feature according to claim 1, characterized in that the core exhibits a diameter of greater than 1 μm.

14. The security feature according to claim 1, characterized in that the core exhibits a diameter that measures between 1 μm and 50 μm, preferably between 5 μm and 20 μm, particularly preferably about 10 μm.

15. The security feature according to claim 1, characterized in that the core exhibits a diameter of less than 1 μm, preferably of less than 600 nm.

16. The security feature according to claim 1, characterized in that the security feature consisting of the core and the shell exhibits a diameter that measures between 0.5 μm and 60 μm, preferably between 1 μm and 20 μm.

17. The security feature according to claim 1, characterized in that, in addition to the acid-labile feature substance functioning as the core of the security feature, also the shell of the security feature fulfills the function of a feature substance.

18. The security feature according to claim 17, characterized in that the shell consisting substantially of metal oxide exhibits characteristic luminescence properties or characteristic magnetic properties or is electrically conductive.

19. The security feature according to claim 17, characterized in that the shell consisting substantially of metal oxide is present doped with a rare earth metal.

20. The security feature according to claim 19, characterized in that the shell consisting substantially of metal oxide is present doped with a metal selected from the group consisting of Pr, Nd, Sm, Eu, Tb, Dy, Ho, Er, Tm and Yb.

21. The security feature according to claim 1, characterized in that an adhesion promoter is present between the core and the shell.

22. The security feature according to claim 1, characterized in that a further shell consisting substantially of metal oxide is present on the shell.

23. A security element for security papers, value documents and the like, characterized in that the security element includes one or more security features as defined in claim 1.

24. The security element according to claim 23, characterized in that the security element forms a security strip, a security thread, a security band or a transfer element for application to or imprinting on a security paper, value document and the like.

25. The security element according to claim 23, characterized in that the security element comprises any further security features.

26. A security paper for manufacturing security documents, such as banknotes, identification cards or the like, characterized in that the security paper includes one or more security features as defined in claim 1, and/or is furnished with one or more security elements for security papers, value documents and the like, characterized in that the security element includes one or more said security features.

27. The security paper according to claim 26 having at least one window area or hole that is covered with the security element.

28. A value document, such as a banknote, passport, identification document or the like, characterized in that the value document includes one or more security features as defined in claim 1, and/or is furnished with one or more security elements for security papers, value documents and the like, characterized in that the security element includes one or more said security features, and/or exhibits a security paper for manufacturing security documents, such as banknotes, identification cards or the like, characterized in that the security paper includes one or more said security features, and/or is furnished with one or more security elements for security papers, value documents and the like, characterized in that the security element includes one or more said security features.

29. A use of security features as defined in claim 1 for manufacturing security paper.

30. A use of a security feature, wherein the security feature has an acid-labile feature substance as the core and a shell consisting substantially of metal oxide, characterized in that the security feature exhibits greater stability against the action of acids compared with the acid-labile feature substance, and indium tin oxide is used as the acid-labile feature substance, of a security element for security papers, value documents and the like, characterized in that the security element includes one or more said security features, of a security paper for manufacturing security documents, such as banknotes, identification cards or the like, characterized in that the security paper includes one or more said security features, and/or is furnished with one or more security elements for security papers, value documents and the like, characterized in that the security element includes one or more said security features, or of a value document according to claim 28 for securing goods of any kind.

31. A method for manufacturing a security feature for security papers, value documents and the like that exhibits an acid-labile feature substance as the core and a shell consisting substantially of metal oxide, characterized in that one or more feature substances are dispersed in a solvent under basic conditions at a pH>8, preferably >9, and subsequently one or more metal oxide precursors dissolved in a solvent are slowly added by drops with vigorous stirring of the presented dispersion of the feature substance, subsequently the precipitate that forms in the course of the reaction of the feature substances and the metal oxide precursors is separated from the supernatant solution, after separation, the precipitate is annealed at elevated temperatures, water, ethanol or a water/ethanol mixture is used as the solvent, and one or more luminescent substances with characteristic luminescence properties are added as the acid-labile feature substance.

32-34. (canceled)

35. The method according to claim 31, characterized in that aqueous ammonia solution is used to set the basic conditions.

36-38. (canceled)

39. The method according to claim 31, characterized in that a metal oxide precursor is added, the metal portion of the metal oxide precursor being selected from the group consisting of aluminum, barium, lead, boron, lanthanum, magnesium, silicon, titanium, zinc, zircon, cobalt, copper, iron and their mixtures.

40. The method according to claim 31, characterized in that a metal oxide precursor is added, the metal portion of the metal oxide precursor being selected from the group consisting of aluminum, silicon, titanium, zircon and their mixtures.

41. The method according to claim 31, characterized in that one or more types of silicon oxide precursors are added.

42. The method according to claim 31, characterized in that, additionally, a metal oxide precursor Me(OR)₃ is added, the metal portion of the metal oxide precursor consisting of a rare earth metal.

43. The method according to claim 42, characterized in that the metal portion of the metal oxide precursor Me(OR)₃ is selected from the group consisting of Pr, Nd, Sm, Eu, Tb, Dy, Ho, Er, Tm, Yb and their mixtures.

44. The method according to claim 42, characterized in that the metal oxide precursor Me(OR)₃ is added in a molar ratio of 1:100 or less to the metal oxide precursor that provides the main component of the shell.

45. The method according to claim 31, characterized in that, as the metal oxide precursor, one or more types of metal organyl compounds Me(OR)ₙ are added, R being an organic residue that can be identical or different, and n=1, 2, 3, 4, 5, 6.

46. The method according to claim 31, characterized in that, as the metal oxide precursor, one or more types of metal organyl compounds Me(OR)ₙ are added, R being selected from the group consisting of alkyl-, alkenyl-, alkynyl-, allyl-, amino-, aryl-, benzyl-, carboxyl-, epoxy- and their mixtures, and n=1, 2, 3, 4, 5, 6.

47. The method according to claim 31, characterized in that, as the metal oxide precursor, one or more types of metal organyl compounds Me(OR)ₙ are added, R being methyl-, ethyl-, propyl-, butyl- or 2-methoxyethoxy- and n=1, 2, 3, 4, 5, 6.

48. (canceled)

49. The method according to claim 31, characterized in that the reaction of the feature substances and the metal oxide precursors is carried out at an elevated temperature.

50. (canceled)

51. The method according to claim 31, characterized in that the reaction of the feature substances and the metal oxide precursors is carried out at a pH value between 8.8 and 9.4.

52. (canceled)

53. The method according to claim 31, characterized in that the separation of the precipitate takes place by filtration.

54. The method according to claim 31, characterized in that, after separation, the precipitate is washed.

55. The method according to claim 54, characterized in that, after separation or after-washing, the precipitate is annealed at elevated temperatures.

56. The method according to claim 31, characterized in that, after separation or after washing, the precipitate is dried by spraying.
